(19) United States
(12) Patent Application Publication
(10) Pub. No.: US 2016/0187937 A1
(43) Pub. Date: Jun. 30, 2016

(54) ELECTRONIC DEVICE CASE AND METHOD OF USE

(71) Applicant: Incipio Technologies, Inc., Irvine, CA (US)

(72) Inventors: Anthony Ahee, Grosse Pointe Shores, MI (US); John M. Schoenith, Hollywood, CA (US)

(73) Assignee: Incipio Technologies, Inc., Irvine, CA (US)

(21) Appl. No.: 14/985,085

(22) Filed: Dec. 30, 2015

Related U.S. Application Data
(60) Provisional application No. 62/098,730, filed on Dec. 31, 2014.

(51) Int. Cl. G06F 1/16; A45C 11/00

(52) U.S. Cl. CPC G06F 1/1681; A45C 11/00; A45C 2011/003

(57) ABSTRACT

A case for an electronic device comprising an upper portion for holding the electronic device; a lower portion; and a hinge portion. The lower portion may include a wireless keyboard that is configured to interact with the electronic device. The upper portion and the lower portion of the case are connected by the hinge portion. The hinge portion includes a housing, a plurality of pins at least partially extending through the housing, and a plurality of hinge connectors. The hinge connectors include a pin sleeve portion rotatably positioned around and at least partially encircling each of the pins and an attachment portion that is attached to either the upper portion or the lower portion. In operation, the hinge facilitates the upper portion being rotatably locked into position relative to the lower portion in one or more predetermined positions. Sensors on the case may be provided to enable/disable the keyboard when the case is opened or closed in a predetermined position.

### INCORPORATION BY REFERENCE TO RELATED APPLICATIONS

This application claims benefit of priority under 35 U.S.C. §119(e) from U.S. Provisional Application No. 62/098,730, filed on Dec. 31, 2014. U.S. Provisional Application No. 62/098,730, U.S. patent application Ser. No. 14/474,586, filed on Sep. 2, 2014, U.S. patent application Ser. No. 14/474,688, filed on Sep. 2, 2014, U.S. patent application Ser. No. 14/056,433, filed on Oct. 17, 2013, U.S. patent application Ser. No. 13/027,740, filed on Feb. 15, 2011, and U.S. Provisional Application No. 61/331,870 filed May 6, 2010 are incorporated herein by reference in their entirety and are to be considered a part of this specification.

### FIELD

The present teachings relate to protective cases for hand-held electronic devices. More specifically, the present teachings relate to cases that both protect an electronic device and modify the functionality of an electronic device.

### BACKGROUND

With a growing number of hand-held electronic devices available to consumers, there is an increasing need for secondary accessories that modify and enhance these devices. Many such accessories exploit existing capabilities of the hand-held devices by enhancing and simplifying a consumer's ability to use the device. As an example, an accessory may be provided to impart additional protection to a hand-held device, so that the risk of damage to certain fragile components of the device is reduced. As yet another example, an accessory may modify a hand-held device so that a modular attachment provides additional functionalities to the device.

One of the more recently developed electronic devices are e-readers or tablet devices having relatively large screens. These tablet devices are often used for reading books, internet browsing, watching stored movies, and other work or recreational activities. Many of these devices, as well as some popular cell phones, and in particular smart phones, have evolved to include a full touch screen and no traditional alpha-numeric keyboard. The size and fragility inherent to these touch screens make them highly susceptible to damage. Touch screens also present additional challenges to extensive word processing use in that the lack of a traditional keyboard generally decreases typing fluidity and speed. Further, most hand-held devices are not equipped for long-term use in that a user must continuously hold or otherwise prop-up the device. Therefore, even though many hand-held devices have the capability to function like a personal computer, most are not designed for such extensive usage.

There remains a need for a secondary accessory for an electronic hand-held device that provides one or more of a protective function, a modification function and an enhancement function for the electronic hand-held device.

### SUMMARY

The present teachings address one or more of the above needs by providing a case for protecting and/or modifying an electronic device. The case includes a hinge portion that connects an upper portion to a lower portion. The upper portion includes a recessed area for receiving an electronic device. The lower portion includes one or more features for modifying the functionality of the electronic device. The hinge portion allows for a plurality of varying arrangements and positions for viewing and utilizing the electronic device.

The present teachings include a case for an electronic device comprising an upper portion for holding the electronic device; a lower portion; and a hinge portion; wherein the upper portion and the lower portion of the case are connected by the hinge portion, wherein the hinge portion includes a hinge body or housing such as that depicted in the drawings, a plurality of pins partially extending from the hinge body, and a plurality of hinge connectors, and wherein each of the plurality of hinge connectors includes a pin sleeve portion rotatably positioned on each of the pins and an attachment portion that is attached to either the upper portion or the lower portion of the case. The upper portion includes a frame portion having one or more edges, wherein the edges engage with the electronic device to hold the electronic device within the case. The upper portion may include a plurality of openings corresponding with features of the case (e.g., charging ports, audio ports, camera lenses). The upper portion may include one or more buttons for engaging one or more buttons of the electronic device (e.g., for controlling volume, power, cameras, and the like). The lower portion may house a keyboard insert, and the keyboard insert may be connected (via wires or wirelessly, such as by BLUETOOTH® wireless technology) to the electronic device so that any data entered via the keyboard insert is received by the electronic device. The keyboard insert may be activated or deactivated depending on the position of the hinge. The position of the hinge may be monitored by one or more sensors, a switch, one or more magnets, or a combination thereof.

The case may include two or more hinge portions. The hinge portion may include features for assisting in rotating the case to form any angle between the upper and lower portions. The hinge may permit movement of the upper and lower portion of about 360 degrees or less. The pins of the hinge portion may include a flat portion. The pin sleeve portion of the hinge connector may include one or more flat segments. The hinge portion may include one or more detents for holding the case in a desired position. The hinge portion may include four pins, such as having two upper pins for actuating movement of the upper portion and two lower pins for actuating movement of the lower portion. The two upper pins may be positioned within two upper hinge connectors, and the two upper hinge connectors may be attached to the upper portion. The two lower pins may be positioned within two lower hinge connectors, and the two lower hinge connectors may be attached to the lower portion. The pin sleeve portions of the two lower hinge connectors may rotate around the two lower pins prior to the pin sleeve portions of the two upper hinge connectors rotating around the two upper pins. It is possible that the case can be held in various positions, such as a closed position by alignment of the flat portion of the at least one pin extending from the hinge body or housing with the one or more flat segments of the pin sleeve portion.

The present teachings also include a method of using the device case, moving the upper and lower portions via the hinge portion, or modifying an electronic device, or combination thereof. The method may comprise the steps of providing an upper portion having a frame portion with one or more edges and a recessed area for receiving an electronic device; providing a lower portion including a base having a planar portion and a keyboard insert; joining the upper portion and lower portion with a hinge portion to form a case, the hinge portion having a hinge body with two or more pins extending from the hinge body and hinge connector that connects the two or more pins to the upper portion or the lower portion via one or more fasteners; and locating an electronic device within the recessed area of the upper portion. The method may include a step of moving the upper portion toward the lower portion so that the electronic device is located between and substantially parallel to the upper portion and the lower portion. The method may include a step of removing the electronic device from the upper portion of the case. The method may include a step of moving the upper portion away from the lower portion so that the upper portion is maintained at an angle of greater than 15 degrees but less than 150 degrees in relation to the lower portion. The method may include a step of moving the upper portion and lower portion so that they are at an angle of about 360 degrees or less. The method may include a step of providing a wireless connection between the keyboard insert and the electronic device so that any data entered via the keyboard insert is received by the electronic device. The hinge portion may include two pins and two hinge connectors for connecting the hinge portion to the upper portion, two pins and two hinge connectors for connecting the hinge portion to the lower portion, or both. The hinge connector may include a pin sleeve portion that rotates around a pin to actuate movement of the hinge portion. The hinge portion may allow for movement of the hinge connectors connected to the lower portion prior to movement of the hinge connectors connected to the lower portion.

The case of the present teachings provides a means for protecting an electronic device while also improving the ease with which the device can be utilized. The case further allows for an electronic device to be integrated into a system which includes additional functionalities that may not be present in the electronic device alone. The case results in improved protection and transport of the electronic device while also providing a user with a standard alpha-numeric keyboard function, power supply for the keyboard device, physical support and additional flexibility in use and function of the electronic device.

### BRIEF DESCRIPTION OF THE DRAWINGS

FIG. 1 is a top view of an electronic device case in a closed position.

FIG. 2 is a perspective view of an electronic device case with the hinge portion forming an angle of less than 180 degrees.

FIG. 3 is a perspective view of an electronic device case with the hinge portion forming an angle of less than 180 degrees.

FIG. 4 is a side view of an electronic device case with the hinge portion forming an angle of less than 180 degrees.

FIG. 5 is a side perspective view of an electronic device case with the hinge portion forming an angle between 180 and 360 degrees.

FIG. 6 is a perspective view of an electronic device case with the hinge portion forming an angle of 360 degrees or less.

FIG. 7 is a perspective view of a hinge portion of an electronic device case.

FIG. 8 is a perspective partial cutaway view of a hinge portion.

FIG. 9 is an enlarged portion of the end of the hinge portion of FIG. 8.

FIG. 10 is a perspective view of a pin of a hinge portion.

FIG. 11 is a perspective view of a hinge connector of a hinge portion.

FIG. 12 is a side perspective view of a hinge connector of a hinge portion.

FIGS. 13A, 13B, 13C, and 13D illustrate side semi-transparent views of a hinge portion of an electronic device case in various positions (closed mode, laptop mode, movie mode, and tablet mode).

FIGS. 14A and 14B illustrate side semi-transparent views of a hinge portion including one or more magnets.

FIGS. 15A, 15B, and 15C illustrate positions of the electronic case for turning the keyboard insert on and off.

### DETAILED DESCRIPTION

The case disclosed herein includes a lower portion, an upper portion and a hinge portion, whereby the hinge portion connects the upper portion to the lower portion. The upper portion includes a recessed area for receiving an electronic device and the hinge portion allows for a plurality of varying arrangements and positions for viewing and utilizing the electronic device. The lower portion may include one or more features for modifying the functionality of the electronic device. These features may include a keyboard insert.

The case includes an upper shell portion and a lower shell portion, the shell portions being the outermost components of the case. The shell portions may be substantially planar or may have a contoured shape. The shell portions not only protect the interior components of the case, but also provide a durable and aesthetically pleasing exterior to the case. The shell portions may each be a unitary component or may be a multi-piece component that requires assembly.

The upper portion may function to contain, support, and/or stabilize the electronic device. The upper portion may be a generally rectangular shape. The upper portion may be a non-rectangular shape, such as a clamshell shape. The upper portion may include an upper shell portion, which protects the case, especially when the case is in the closed position. The upper shell portion may be generally planar. The upper shell portion may be generally solid (e.g., a continuous piece of material, such as a metallic or plastic material). The upper shell portion may have one or more openings (e.g., to allow a user to see a logo on the back of the electronic device opposite the screen, to ease installation or removal of the electronic device, for aesthetic purposes, for preventing overheating of the electronic device, or combination thereof).

The upper portion may include a frame portion having one or more edges. The frame portion and/or the one or more edges may assist in securing the electronic device within the upper portion of the case. The edges that form the upper frame may lie substantially perpendicular to the upper shell portion. One or more of the edges that form the upper frame may include a lip arranged adjacent or on the edge and substantially perpendicular to the edge to assist in maintaining the location of an electronic device located within the upper frame. Upon insertion of an electronic device into the upper frame, a portion of the front surface of the electronic device will contact the lip thereby preventing the device from becoming disengaged from the upper frame. The upper shell portion, an edge and an adjacent lip may together form a pocket for receiving the electronic device.

One or more edges may further include a cut-out portion whereby a user can contact an electronic device located within the upper frame to remove the electronic device from the frame. The edges and/or lip of the edge may provide a friction fit for the electronic device. For example, one or more edges may act as a lip and may have an area that slightly overlaps a portion of the electronic device (e.g., an edge of the electronic device) when it is installed without inhibiting access to the screen. This allows the electronic device to be retained within the case but does not obstruct the user's ability to see or use the screen. The frame portion and/or one or more edges may be an integral part of the upper portion. The one or more edges may be one or more separate pieces that are attached to the upper portion (e.g., a rectangular discrete piece or multiple pieces attached separately). Attachment may be provided by one or more adhesives, fasteners, clips, friction fit, or combination thereof. The upper portion may include a front edge opposite the hinge portion, a rear edge adjacent and/or attached to the hinge portion, and one or more side edges (e.g., generally parallel to each other, generally perpendicular to the front and/or rear edges, or both). Two or more edges may be generally parallel with each other.

The electronic device may include one or more clips or other securing elements. The clip may be connected to the upper frame and selectively rotated into position to prevent dislodgment of the electronic device from the recessed area (e.g., rotatable elements that can be rotated to hold the case in place when located in the upper portion, and rotated away when the case is to be removed).

The hinge portion may be connected to any part of the upper portion, such as the upper shell or the frame portion. The upper portion may include one or more intermediate securing portions, such as a plate, a wall, or a bar (any or all of which may have an opening for receiving a fastener), adjacent the hinge to allow the hinge portion to be connected to the upper portion (e.g., via one or more fasteners and a hinge connector).

The upper shell portion may include one or more raised surfaces and/or edges extending from the upper shell portion to form a recessed area. These raised surfaces may assist in locating and supporting an electronic device placed within the recessed area. The recessed area may be a cavity formed between the upper shell portion and the upper frame so that an electronic device can be located within the recessed area created by the upper shell portion and upper frame. The recessed area may at least be partially defined by the upper shell portion of the upper portion and one or more edges of the frame portion. The recessed area may include an area (such as a pocket) for receiving an edge of the electronic device, the pocket being located substantially parallel to at least one edge of the upper portion. The electronic device may be located within the recessed area of the upper portion so that an edge of the electronic device contacts the pocket for receiving an edge of the electronic device.

The electronic device may be secured within the upper portion of the case. A user may be able to insert and remove the electronic device when desired. For example, a user may be able to snap the electronic device into the upper portion. The electronic device may be inserted into the case directly without having to insert one edge of the electronic device before another. The electronic device may be angularly inserted and seated into an area between an edge of the frame and the recessed area (e.g., the pocket). The user may then push the opposing end of the electronic device so it is angularly rotated into a flush, or substantially flush position with the other three sides/edges of the frame portion of the case. The area between an edge and the recessed area (e.g., the pocket) is preferably sized to accommodate the width or thickness of an e-reading device or tablet. The pocket may be located at the rear edge generally parallel to and adjacent the hinge portion, at the front edge of the upper portion (i.e., the edge furthest from the hinge portion), or pockets may be located in both areas. The depth of the pocket may be relatively small. The depth of the pocket may be about a quarter (¼) inch deep from the frame edge or less, about an eighth (⅛) of an inch deep or less, or even a sixteenth ( 1/16) of an inch or less. When the electronic device is located within the upper portion, one or more of the edges may be free of contact with the front face or screen of the electronic device (e.g., to avoid blocking any of the screen).

To remove the electronic device, a user may grip the front edge (i.e., the edge furthest from the hinge portion) and pull the edge away from the electronic device. This will disengage the lip of the edge and will allow a user to pull the electronic device from the upper portion.

The portion of the case receiving the electronic device (i.e., the upper portion) may include one or more openings that correspond to openings or features of the electronic device. For example, the upper portion may include an opening (i.e., an electronic device charger opening) that corresponds with the charging port or area for receiving a charger of the electronic device. This allows a user to charge the electronic device while still using the case and/or without having to remove the electronic device from the case.

The case may include a plurality of openings corresponding to the speaker of the electronic device for allowing a user to hear the sounds coming from the speakers of the electronic device and/or for amplifying the sound of the speakers of the device. The openings may also correspond with the microphone of the electronic device so that the electronic device can capture sound from a user speaking (e.g., when giving a command verbally to the electronic device, when recording audio or video, and the like). The case may include one or more audio device openings, USB openings, and the like, corresponding with like openings in the electronic device for receiving an audio device (e.g., headphones, microphone, or adapter for accepting audio devices not typically accepted by the device), a USB plug or cable (e.g., for a portable storage device, such as a memory stick or flash drive; connector to connect the electronic device to another computer or electronic device; computer peripherals such as cameras, printers, disk drives, mouse, and the like; or combination thereof), or other element able to be plugged in to an electronic device. The case may include one or more lens openings corresponding with the camera lens of the electronic device. This allows a user to take photos or capture videos, for example, when the electronic device is still in the case.

The upper portion may also include one or more buttons. These buttons may correspond with the buttons of an electronic device. The buttons of the upper portion may lie directly on top of the buttons of the electronic device when the electronic device is secured within the case. This button-on-button feature allows a user to control aspects of the electronic device (e.g., volume controls, power controls, camera, and the like) without having to directly press the buttons of the electronic device. By pressing the button of the case, the button of the case is pushed into the button of the electronic device. The button of the case may also include a projection or feature that slightly extends on the opposing side of the button (i.e., the side of the button contacting the button of the electronic device) to ensure contact between the buttons when a user presses the button of the case. The upper portion may instead include one or more cutouts for providing direct access to the buttons or openings of the electronic device.

The lower portion of the case may function to provide support to the case, reduce the likelihood of the case tipping over in particular positions (e.g., by providing counterweight to the weight of the upper portion when holding the electronic device), provide protection to the case, or combination thereof. The lower portion of the case may function to house additional components that communicate with the electronic device. The lower portion of the case may function to house additional components that allow the case to be used in its intended manner. For example, the lower portion may house a keyboard, power supply (e.g., a battery), BLUETOOTH wireless control device, other accessory devices and/or controllers, or a combination thereof. Preferably, the lower portion houses at least a keyboard. The keyboard may be an insert that is inserted into an opening in the lower portion.

The lower portion may include a front edge, a rear edge, and two side edges. The front edge may include one or more grooves or contours to allow a user to open the case after it has been in a closed position. The lower portion may include a base having a planar portion. The planar portion faces inwardly opposite the screen of the electronic device (e.g., the area that receives the heels of a user's hands). The lower portion may include a lower shell portion, which is the external exposed portion when the case is in its closed position. The lower portion may include a frame that provides support to the case. The lower portion may also include one or more intermediate plates, platforms, and the like for supporting components of the lower portion, for providing protection to components of the lower portion, for separating elements of the lower portion, or any combination thereof.

The lower shell portion may be attached to the frame of the lower portion. The lower shell may be attached via an adhesive, a mechanical fastener, or may be engaged with the frame by a friction fit. The lower shell portion and lower frame may be arranged in planar contact with one another and may further be of substantially the same size and shape. The length of the lower shell portion and frame may thus be substantially similar to the length of the electronic device and/or keyboard insert placed within the case. Alternatively, the length of the lower shell portion and frame may be greater than the length of the electronic device and/or keyboard located within the case. Preferably, the length, width, and shape of the lower shell portion and frame are substantially similar to that of the base of the lower portion. The base of the lower portion may thus be located in contact with the frame, so that the base, frame and lower shell portion all lie substantially parallel to one another. The frame may be attached to the base via a plurality of mechanical fasteners (e.g., screws). Alternatively, the frame may be attached to the base via an adhesive or friction fit. As an example, the base and outer shell may be attached to one another along the perimeter of each so that the frame is contained within the attached base and outer shell.

The frame of the lower portion provides a support structure to the base and keyboard insert. The frame may include a lattice structure or may be a formed of a continuous sheet of material. The frame may include one or more openings for receiving an attachment means. As an example, the frame may include a plurality of apertures for receiving a plurality of mechanical fasteners. The frame may also be located adjacent one or more intermediate plates. The one or more intermediate plates may be located so that they cover the entire top surface of the frame or may be arranged so as to cover only a portion of the frame. The one or more intermediate plates may be located beneath the one or more openings in the planar portion to provide support and/or connectivity for any user interface device (e.g., keyboard, mouse, touchpad, storage device etc.) located within the openings.

The lower portion may include one or more intermediate plates between the planar portion and the lower shell portion. These plates may be in planar contact with each other or with other elements of the lower portion. The plates may be secured to the hinge portion of the case (e.g., via one or more fasteners and the hinge connector). The plates may be secured to each other, to the base, to the lower shell portion, or a combination thereof by one or more mechanical fasteners (e.g., screws). The mechanical fasteners may be covered by one or more caps or pads so that the fasteners are not visible. The caps or pads may be a rubberized and/or elastomeric or other anti-slip and/or cushioning material so that the caps or pads also may prevent unwanted movement or may provide cushioning or elevation to the case (such as by preventing contact between the screen of the electronic device and the keyboard insert, contact between the keyboard and a substrate when in movie or tablet mode, or both). Caps or pads may also be applied or adhered to any portion of the case, even if not concealing one or more mechanical fasteners. Thus, any surface of the case that may contact a substrate during case use may include one or more caps or pads.

The frame may also contact one or more platform structures. The platform structures may be located between the base and the frame. More specifically, the platform structures may be located beneath the planar portions of the base and adjacent the openings of the base so as to offset pressure on the depression portion of the base. The platform portions may extend beneath only a portion of the planar portion of the base, or may extend beneath the entire planar portion of the base. The platforms may also include one or more openings for receiving an attachment means. As an example, an attachment means may extend through the frame and through a platform portion

The location of the platform structures adjacent the depression portion of the base may create a cavity between the frame and the base that can be filled by the thickness of the platform structures. Alternatively, one or more platform structures may contain one or more ports or additional structures that fill the cavity and facilitate a function of the case when an electronic device is located within the case. For example, a platform structure may include a port for receiving a power supply, or a port for connecting the case (and thus the electronic device) to a secondary device, such as a modem, cellular phone, or storage device. As another example, while installed in the case, the electronic device could be connected to a power source (which may or may not be integrated into the case itself) to charge an internal battery of the electronic device. The electronic device could be connected to a USB cord or other communication cables for transfer of data or signals between a secondary device for enhanced viewing or processing by the primary electronic device.

The lower portion may further include a counterweight located adjacent the lower shell, the frame, or the platform structures. Such a counterweight may be useful in offsetting the weight of the electronic device mounted in the upper portion for a balanced and stable platform for the electronic device. The platform structures themselves may also be the source of the counterweight.

The lower portion may include a keyboard insert. The keyboard insert may be inserted into a depression portion (e.g., a large, recessed opening in the planar portion). The depression portion may allow the keys to be flush, or substantially flush with the planar portion. At least a portion of the keyboard insert may be located below the planar portion, and the planar portion may have one or more openings for receiving the keys of the keyboard. For example, the planar portion may include a plurality of openings to receive the individual keys of the keyboard. Instead, the planar portion may include one or more larger openings for exposing a plurality of keys.

The lower portion may include a light source to allow the keyboard to be backlit. Keys of the keyboard may include standard letters and numbers. Keys may also provide the user with options to control volume, battery status, BLUETOOTH wireless functionality, the appearance of an on-screen keyboard, and international keyboard, a lock to the device, the ability to go to the home screen of the electronic device, the option to pull up a particular browser or search engine, a button for enabling the microphone of the electronic device, options for playing, pausing, fast forwarding, rewinding, adjusting brightness, or any combination thereof.

The lower portion may also include one or more lights (e.g., LED lights). When prompted, these lights may flash to indicate battery life of the case, of the electronic device, or both. A user may press a particular key or keys on the keyboard (e.g., fn+the battery key simultaneously) which may cause lights to flash to indicate the life of the battery (e.g., 4 flashes being 100-75% battery life, 1 flash being 25-0% battery life).

The lower portion may also house additional components, for example, a power supply, a BLUETOOTH wireless control device, and other accessory devices and/or controllers. As an example, the keyboard insert communicates with the electronic device through the BLUETOOTH wireless protocol to send signals to the electronic device which are read and executed by the onboard operating system and controllers in the electronic device. This eliminates the need for wiring harnesses and electronic connections between the electronic device, keyboard insert, or any other secondary electronic device that may be connected with the case. The power supply may provide power to run the BLUETOOTH wireless control device, power to run the keyboard insert, and/or power to run any other case accessories. A power source may be located within the case to provide power to the electronic device itself. A power switch to enable and disable the BLUETOOTH wireless system may also be integrated into the upper or lower portion. Alternatively, a physical and electronic connection can be made between the electronic device and the case depending upon the primary and/or secondary electronic devices being used or the application of such devices. Such secondary electronic devices are preferably positioned within the lower portion and may be independent or connected through other controllers or processors in order to maximize the efficiency and functionality of the case with the selected primary and/or secondary electronic devices.

During use, the case is opened by a step of rotating the upper portion relative to the lower portion about the hinge portion thereby exposing the recessed area of the upper portion. The electronic device, for example an e-reader/tablet device, is positioned within the recessed area. Depending upon the application, the user then manipulates the upper portion and lower portion for ease of use, for example rotating the upper portion about 330° away from the lower portion and standing the case on a firm, substantially horizontal surface so that the visual screen of the electronic device is readily viewable by the user. If the case is equipped with a keyboard insert, a BLUETOOTH wireless controller may establish communication between the keyboard insert and the electronic device so that the user can input data through the keyboard insert and to the electronic device. If the user wishes to use the electronic device in a tablet configuration, the upper portion may be rotated to a fully open position whereby the upper portion is positioned substantially 325° away from the lower portion so that only the upper portion and electronic device are visible to the user as the lower portion is positioned substantially behind the upper portion. In the event that the user desires to utilize the full protection of the electronic device by the case, the upper portion is rotated to a closed position substantially encompassing the entire electronic device by the upper portion and lower portion.

The upper portion and lower portion are joined by a hinge portion that allows the case to be used in multiple positions. The case may be opened to one or more partially and/or fully extended positions. The front edges of the upper and lower portions can be separated while the rear edges are joined at the hinge to form an angle. The angle can be any angle ranging from about 0 degrees to about 360 degrees.

The upper portion and lower portion may lie generally parallel to each other (e.g., the upper portion on top of the lower portion to form an angle of about 0 degrees), which allows the case to be in a “closed mode”. In closed mode, the screen of the electronic device located within the upper portion faces the keyboard insert in the lower portion of the case. This mode provides protection to the electronic device, such as during carrying the electronic device while it is not in use.

The case can be opened with the upper portion and lower portion lying generally parallel to each other (e.g., forming an angle of about 360 degrees or less, about 340 degrees or less, or about 330 degrees or less), which allows the case to be in a “tablet mode”. In tablet mode, the screen of the electronic device and the keyboard of the lower portion may be facing opposite directions and both exposed. This allows the user to use the electronic device like a traditional tablet, such as by utilizing the touchscreen without the keyboard associated with the case.

The upper and lower portions can be arranged in any configuration in between. In a “laptop mode”, the angle formed between the lower portion and upper portion can be between about 0 degrees or greater, about 45 degrees or greater, or about 75 degrees or greater. The angle formed may be about 180 degrees or less, about 150 degrees or less, or about 125 degrees or less. This allows a user to type on the keyboard insert while also viewing the screen of the electronic device.

The upper and lower portions can lie in generally the same plane to form an angle of about 180 degrees (i.e., with the tablet screen and keyboard insert exposed and facing the same direction). In a “movie mode”, the angle formed between the lower portion and upper portion is about 180 degrees or greater, about 200 degrees or greater, or about 220 degrees or greater. The angle formed may be about 355 degrees or less, about 340 degrees or less, or 300 degrees or less. For example, a user wishing to watch a movie or video without holding the electronic device could position the keyboard so it is facing downward onto a substrate, such as a table, to serve as a base to support the electronic device and hold it in a desired position so that the screen is visible to the user. The user could instead support the case by positioning the front edges of the upper and lower portions onto a substrate (e.g., to generally form a triangle between the case and the substrate, with the keyboard insert and the screen of the electronic device facing outwardly). It is also possible that a side edge of the lower portion of the case and a side edge of the upper portion of the case are rested on a substrate so that the electronic device may be viewed in a vertical position.

The case may include one or more hinge portions. The hinge portions may function to join the upper and lower portions of the case, permit movement and adjustment of the angles between the upper and lower portions, secure the case in desired positions, assist in automatic enabling and disabling of the keyboard insert, or any combination thereof. The hinge portion may generally include a hinge body, two or more pins at least partially located within openings in the hinge body, and a hinge connector that connects each pin to the upper or lower portions of the case. The hinge portion may be a single hinge body with multiple pins. For example, a single hinge body may receive four pins, with two pins connected to the upper portion and two pins connected to the lower portion. Instead, for example, two hinge portions may be used (e.g., toward opposite corners of an edge of the case and separated by a gap). In a case having two (or more) hinge portions, each hinge portion could have four pins (two pins connected to the upper portion and two pins connected to the lower portion). In the alternative, each hinge portion could have two pins (one upper pin connected to the upper portion and one lower pin connected to the lower portion).

The hinge body may be a generally elongated body having a length, a width and a thickness. The thickness of the hinge body may be generally constant or the thickness may generally vary along the width of the hinge body. The hinge body may have a generally rectangular cross section, a generally ovular cross section, a cross section generally shaped like a D, generally rounded or curved edges, or any other shape. The hinge body may have one or more hollow portions, one or more openings for receiving at least a portion of a pin, or both. The hinge body may include one or more support structures in a hollow body for providing support to the walls of the hinge body. The hinge body may be formed by an extrusion process, a molding process, a cutting process, or any type of process for assembling a three-dimensional hinge structure. The hinge body may be made of an anti-slip material, have an anti-slip coating, or both. The width of the hinge body may be generally the same as the thickness of at least a portion of the case, so that when the case is in a closed position, the hinge body is generally in line with the upper and lower portions of the case. The hinge body may have one or more flat sides (e.g., parallel flat sides). The hinge body may have one or more curved portions. The hinge body may have one side that is generally flat (e.g., the portion facing inside when the case is in a closed position). The hinge body may have one or more sides that are generally curved (e.g., the portion facing outwardly when the case is in a closed position). The hinge body may have one or more curved sides that allow the hinge and/or the upper portion or lower portion to rotate as the position of the case is adjusted. The hinge body may also have one or more exterior projections (e.g., at or near an opening in the hinge body) for providing further support, for assisting in rotation, for maintaining desired positions of the case, acting as a detent, or any combination thereof.

The openings in the hinge body for receiving the pins may be located at one or more ends of the hinge body. For example, a hinge body may have two openings at one end of the hinge body and two openings at the opposing end of the hinge body. Each opening may receive a portion of a pin, with the upper two pins on opposing ends of the hinge body secured to the upper portion of the case, and the lower two pins on opposing ends of the hinge body secured to the upper portion of the case. The pin may be held in place within the hinge body so at least a portion of the pin is not able to rotate when the positions of the upper and/or lower portions of the case are adjusted. The pins may have a portion that protrude from the end of the hinge body. The pin structures may have a generally cylindrical body. The pin structures may include a generally flat portion, which interacts with the hinge connector to act as a detent to maintain positions of the case until it is manually adjusted by a user. The pin structures may be made of metal, plastic, or any suitable material.

The protruding portions of the pins may be received by a hinge connector. The hinge connector allows for movement of the hinge portion and the upper and lower portions of the case, acts as a detent to snap or secure the case into certain positions, connects the hinge portion to the upper and lower portions of the case, determines the hinge actuation order (i.e., allowing for rotation of the hinge between the lower portion and hinge portion before rotation of the hinge between the upper portion and the hinge portion, or vice versa), or any combination thereof. The hinge connectors may have different shapes and features, depending on the location of the hinge connector in the hinge portion. For example, a hinge connector connecting a pin and the lower portion of the case may be shaped differently to reduce friction or otherwise allow the hinge connector portion to rotate before a hinge connector connecting a pin and the upper portion of the case.

The hinge connector may include a pin sleeve portion for receiving the protruding portion of a pin when it is inserted into the hinge body. The pin sleeve portion may be generally cylindrical. The pin sleeve portion may have one or more flat segments. When a user changes positions of the case, the hinge connector rotates around the pins. The hinge portion may include one or more features that serve as a detent to secure the case in various positions of use (e.g., closed mode, laptop mode, tablet mode). In certain positions of the case, the flat segments of the pin sleeve portion may contact or otherwise interact with the flat portion of the pin, which allows the case to be held more securely in that position, to snap into that position, or both. For example, in a closed position, in tablet mode, or in both, a flat portion of the pin and the flat segment of the pin sleeve portion may align so that the case is held closed and/or the upper and lower portions do not spring open or apart. Other features may also hold the case in the closed position, such as one or more latches, clips, magnets, or the like. In another example, the hinge connector rotates until the flat portion of the pin and the flat segment of the pin sleeve portion of the hinge connector align to secure the case in laptop mode (e.g., snapping the case into position at a particular angle before the case would topple over). While it is contemplated that the case can be positioned and used in generally any position, these flat portions and flat surfaces may help to hold the case in positions most used or where a user may desire additional securing.

The hinge connector may include an attachment portion for attaching the hinge connector to the upper portion or the lower portion of the case. The attachment portion may be a generally planar segment. The attachment portion may include a plurality of openings for receiving fasteners to fasten the attachment portion to the upper portion or lower portion of the case. The shape of the attachment portion may vary depending on the location of the hinge connector (e.g., attached to the upper portion or lower portion of the case). As shown in the drawings, the shape of the upper attachment portion may be different from the shape of the lower attachment portion. A longer upper attachment portion (e.g., extending beyond the pin sleeve portion) may be used for the hinge connector connecting the upper portion to the hinge portion. This longer attachment portion may distribute the force from a user rotating the upper portion of the case over the length of the attachment portion, which may allow for ordering the hinge actuation (e.g., by assisting or allowing for the lower hinge connectors to begin to rotate around the lower pins before the upper hinge connectors begin to rotate around the upper pins of the hinge portion, or vice versa).

The hinge portion may allow for rotation of the hinge connector around one set of pins (e.g., opposing pins attached to the same portion of the case) before rotation around the other set of pins. For example, rotation of the lower pin sleeve portions about the lower pins and connected to the lower portion may occur first when a user opens the case from closed position. When the lower rotation has begun, has completed (e.g., when it cannot rotate any further, such as when the case is open about 180 degrees or more) or has nearly completed, the rotation of the upper pin sleeve portions about the upper pins connected to the upper portion may begin or complete the transition into movie mode and/or tablet mode. It should be understood that this can be performed vice versa, with rotation about the upper pins occurring first or before rotation about the lower pins.

In various positions, it may be undesirable for the keyboard insert to function (e.g., preferable to disable the keyboard functionality in certain positions where the keyboard is not positioned for use). For example, the keyboard need not be enabled when the case is in closed mode or tablet mode. A keyboard may be most useful when it is in laptop mode. Therefore, the case may include a manual switch to enable a user to turn the keyboard on and off. The case may include a mechanism for automatically switching the keyboard on and off when the case is at particular angles. The hinge portion may include one or more magnets (e.g., a magnet on opposing sides of the pin at the lower portion of the case). The magnets may be pressed into caps of the hinge portion or may be inserted during extrusion of the hinge body. The magnets may work in conjunction with a sensor or a switch so that the keyboard is automatically disabled or enabled as previously described when the case is in particular positions. The switch or sensor may be located in the lower portion of the case. The switch or sensor may be placed close to the magnets, and localized thinning of the wall of the lower portion near the magnet may be included which may improve detection. For example, when the magnets align with the switch or sensor located in the lower portion of the case (e.g., on the printed circuit board assembly), the keyboard may be disabled. When the magnets are not aligned with the switch or sensor, the keyboard will be active (e.g., functional).

Although the case described herein includes illustrations relating to its use with an e-reader/tablet style device such as the iPad® mobile device (iPad is a trademark of Apple, Inc.), it is understood that the case can be formed in alternative sizes, shapes and configurations to serve as a case having the described features and utilities for other electronic devices such as smart phones, MP3 players, computing devices, and other popular electronic devices. The case may provide increased utility and functionality by including an integrated keyboard (as illustrated, but not required), is easily manipulated to serve as an upright and secure stand for an electronic device and functions as a protective cover and travel case for everyday use and protection for portable and mobile electronic devices.

Materials providing the requisite rigidity to protect an electronic device located within the case may include polymeric materials including but not limited to thermoplastics, thermoset plastics, elastomeric containing materials or any combination thereof. Examples of polymeric and elastomeric materials that may be employed include nylon, polyvinyl chloride, polypropylene, high-density polyethylene, low-density polyethylene, linear low-density polyethylene, polyvinylidene chloride polyamide, polyester, polystyrene, polyethylene, polyethylene terephthalate, bio-based plastics/biopolymers (e.g., poly lactic acid), silicone, acrylonitrile butadiene styrene (ABS), rubber, polyisoprene, butyl rubber, polybutadiene, EPM rubber, EPDM rubber, or any combination thereof. Additional suitable materials may include bio-plastics such as those derived from wood pulp-based lignin (e.g., liquid wood), sugarcane or other petroleum-free moldable materials.

Different components of the case may be composed of different materials. As an example, the upper shell portion and lower shell portion may comprise different materials than the base or keyboard insert. As previously discussed, one or more surfaces of the case (including the upper portion, lower portion and hinge portion) may include rubberized/elastomeric cap portions or pads to prevent the case from slipping from or relative to a surface during case use. The upper portion and lower portion can be made from an ABS plastic material. Where a more pliable material is used, for example an elastomer, the upper frame may have a lip that surrounds the frame so as to be manually stretched around the corners of an electronic device to hold the device in the recessed area without additional clips, fasteners or other devices. A tactile or textured coating may be provided on the exterior of the hinge portion which provides a comfortable and sure gripping surface for a user for ease of carrying or in the many different configurations the case may be placed in.

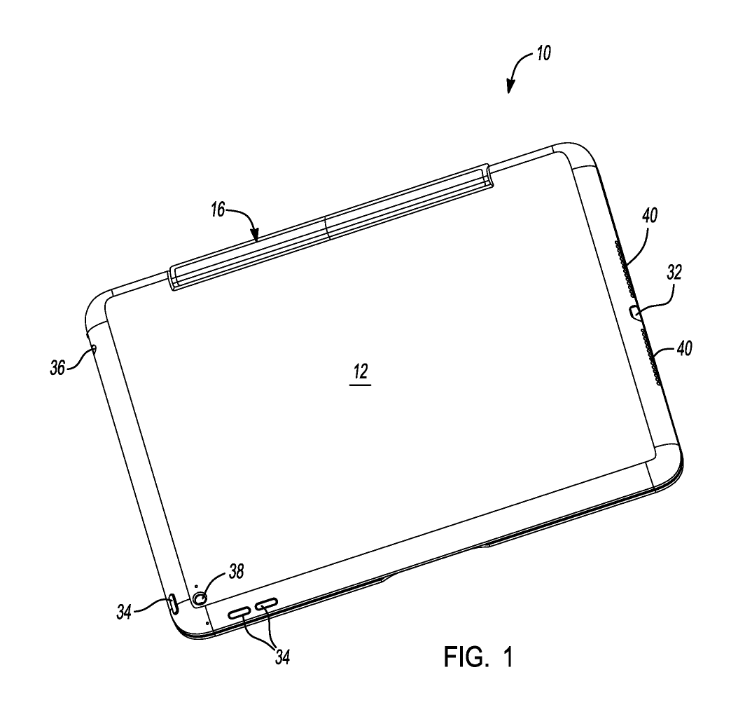

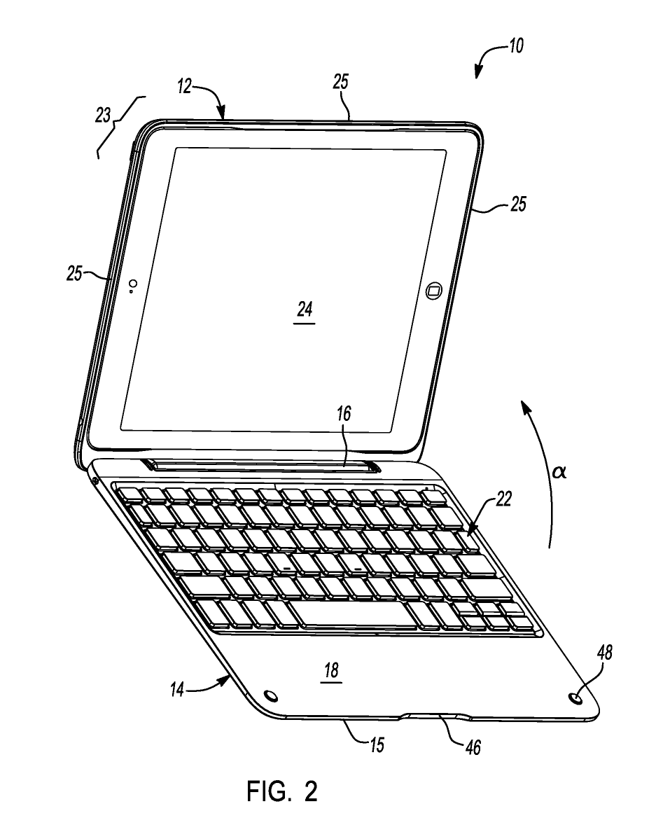

FIG. 1 illustrates a top view of a case 10 in a closed position having an upper portion 12, a lower portion 14 (see FIG. 2), and a hinge portion 16 that connects and allows the upper and lower portions to hingedly move relative to each other. The case 10 includes an electronic device charger opening 32 that corresponds with the charging port of the electronic device 24 (see FIG. 2), which allows the electronic device to be charged while still housed within the upper portion 12 of the case 10. The case 10 includes a plurality of exterior buttons 34 that correspond with buttons of the electronic device (e.g., buttons that control power, volume, and the like). This creates a button-on-button arrangement so that a user pushing an exterior button 34 of the case 10 pushes the corresponding button on the electronic device 24 itself. The case 10 includes a lens opening 38 for providing access to the lens of the camera of the electronic device, thereby allowing a user to take pictures, video, or other recordings while the electronic device is in the case 10. The case 10 also includes an audio device opening 36 corresponding with an audio jack (such as for receiving headphones) of the electronic device. The case 10 includes a plurality of speaker holes 40 corresponding with the speakers of the electronic device.

FIG. 2 illustrates the case 10 including an electronic device 24 secured within the upper portion 12 in the frame portion 23 including edges 25 that allow the electronic device 24 to snap into place. The frame portion 23 defines the area that receives and holds the electronic device 24. The electronic device 24 may be snapped in, such as by angularly inserting the electronic device 24 (e.g., at the area of the case closest to the hinge portion 16) and pushing the opposing side of the electronic device 24 so that it is angularly rotated into a flush, or substantially flush position with the other three edges 25 of the frame portion 23. The lower portion 14 of the case 10 includes a planar portion 18 (e.g., for supporting the heels of a user's hands when using the case). The lower portion includes a keyboard insert 22 to allow the user to type with a keyboard rather than on the screen of the electronic device 24. The lower portion 14 has a front edge 15 that includes a depression 46 that allows a user to be able to more easily open the case 10 when it is in a closed position (see FIG. 1). The case 10 includes one or more pads 48 that reduce slippage and provide cushioning when the case 10 is in various positions. The hinge portion 16 allows the case to be opened to an angle α that is less than 180 degrees (measured as the angle between the upper portion 12 and the lower portion 14 and joined at the hinge portion 16). This arrangement, or laptop mode, allows a user to be able to view the screen of the electronic device 24 and type on the keyboard insert 22, similar to a traditional laptop computer.

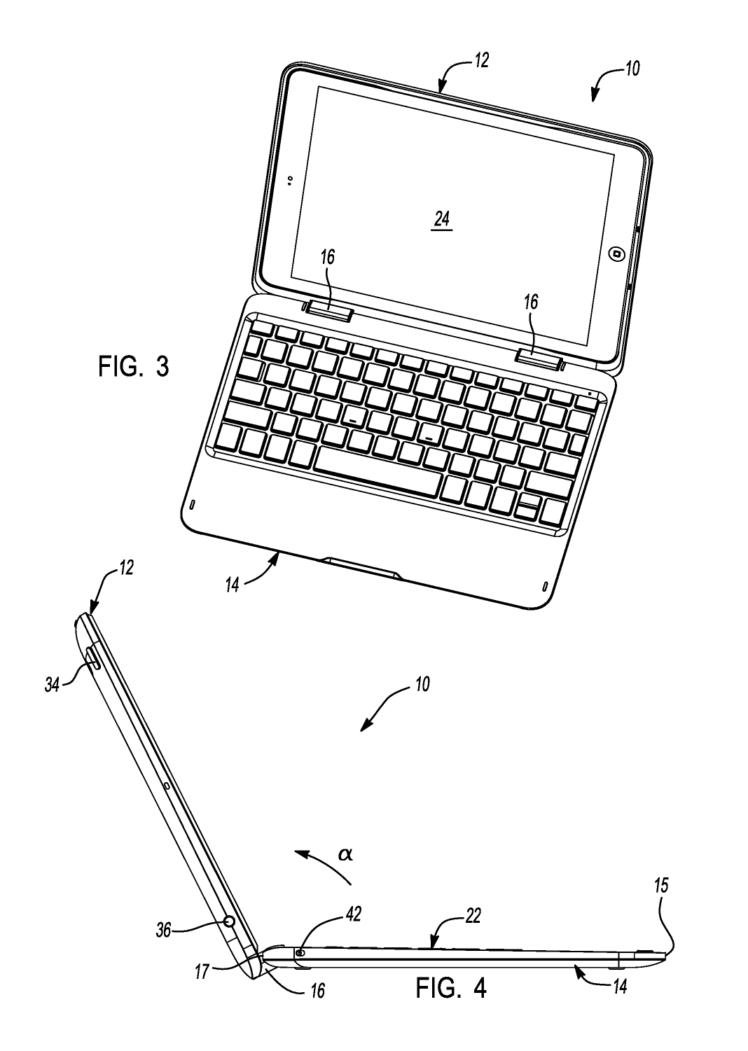

FIG. 3 illustrates a case 10 in laptop mode. The case 10 includes an upper portion 12 for holding an electronic device 24, and the upper portion 12 is joined to a lower portion 14 with two hinge portions 16.

FIG. 4 illustrates a side view of the case 10 in laptop mode, where the upper portion 12 and the lower portion 14 are joined at the hinge portion 16 to form angle α, which is less than 180 degrees. The case 10 includes exterior buttons 34 and an audio device opening 36 that correspond with the buttons and ports (e.g., headphone port), respectively, on the electronic device 24 (see FIGS. 2 and 3). The case 10 also includes a case switch 42 that allows a user to manually turn on the case and/or BLUETOOTH wireless communication to permit communication between the electronic device 24 and the case 10. In laptop mode, the keyboard insert 22 is slightly elevated, as the case 10 rests on the hinge portion 16 and lifts the rear edge 17 of the lower portion 14 higher than the front edge 15.

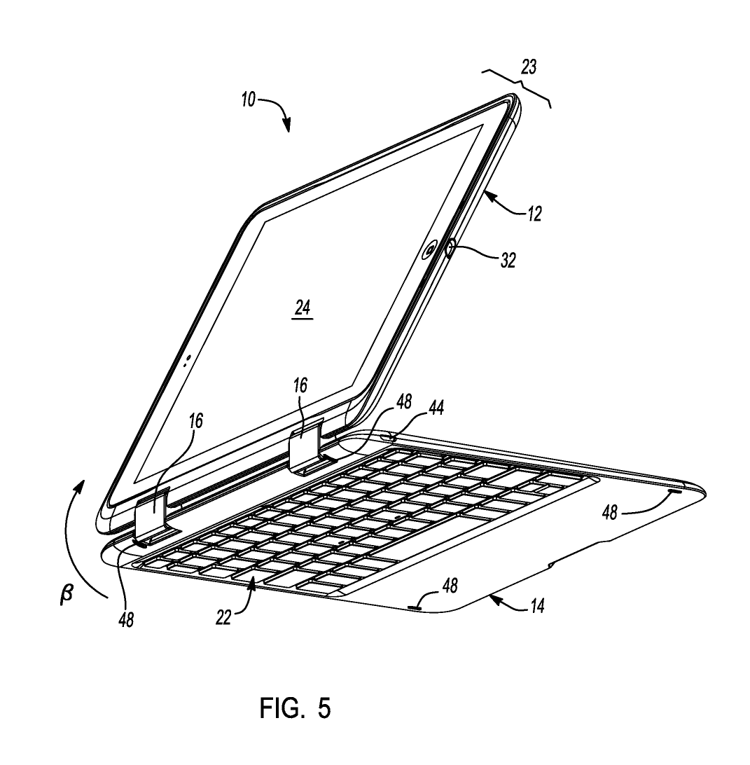

FIG. 5 illustrates a case 10 with the upper portion 12 joined to the lower portion 14 at the hinge portions 16. The electronic device 24 is held in the upper portion 12 by the frame portion 23. The upper portion 12 includes the electronic device charger opening 32 for allowing a user to insert a charger (not shown) into the charging port of the electronic device 24. The lower portion 14 includes a case charging port 44 for receiving a cable/charger (not shown) to charge the case 10. The case 10 includes pads 48 that prevent the case from sliding when it is positioned on a substrate such as a table (not shown). The hinge portions 16 allow the case 10 to be opened to an angle 13 that is greater than 180 degrees. This configuration, or “movie mode,” allows the user to be able to use the electronic device 24 (e.g., to watch a streaming video, movie, or the like) without having to hold the device with his or her hands. In this configuration, the keyboard insert 22 faces downward (e.g., toward the substrate such as a table), and the pads 48 also assist in protecting the keyboard insert 22 by providing slight elevation.

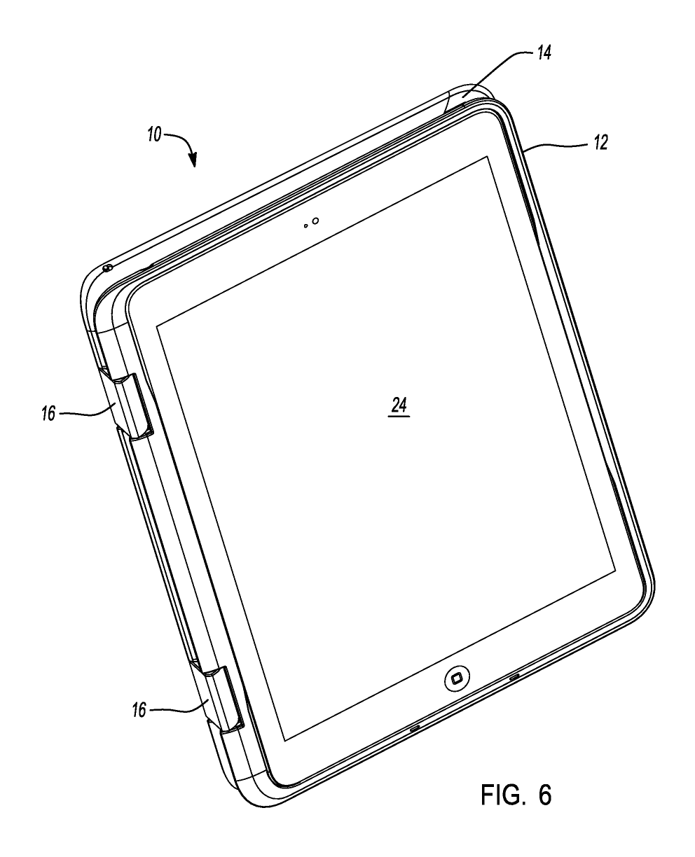

FIG. 6 illustrates a case 10 with the upper portion 12 and lower portion 14 being parallel to each other, with the keyboard insert (not shown) and the face of the electronic device 24 facing away from each other. The hinge portion 16 allows the case 10 to be opened to an angle of about 360 degrees. This configuration, or “tablet mode,” allows the user to be able to use the electronic device 24 as a tablet (e.g., using the touchscreen to operate and control the electronic device).

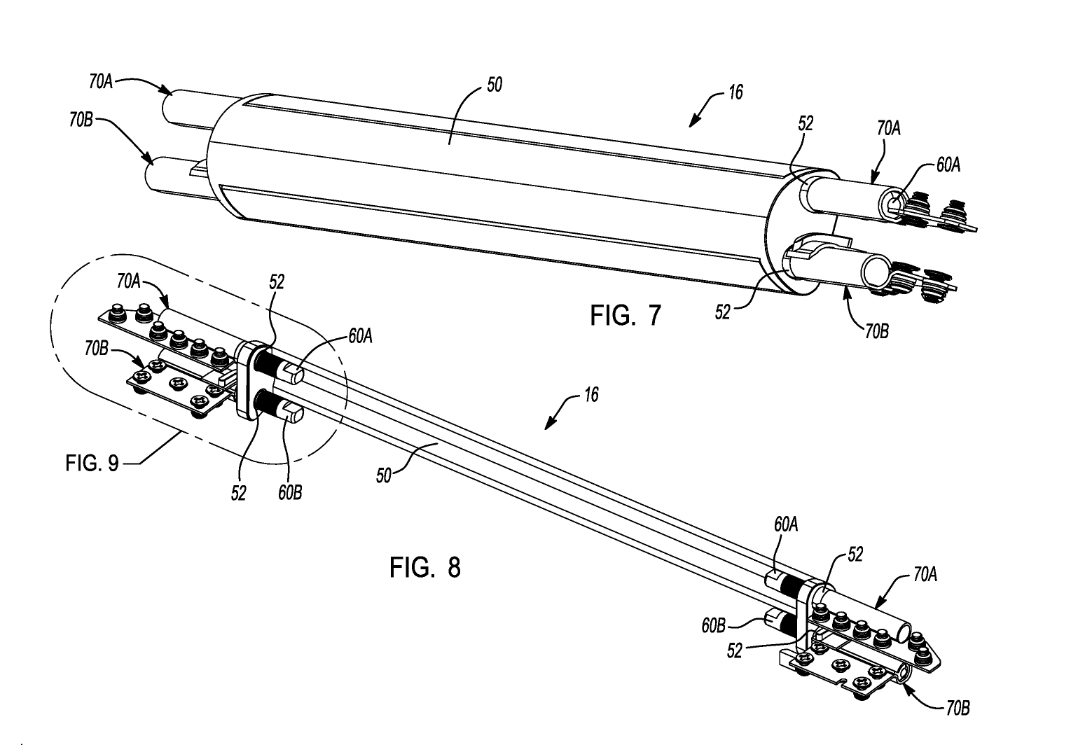

FIG. 7 illustrates a hinge portion 16 detached from the case (not shown). The hinge portion 16 includes a hinge body 50 having openings 52, each opening 52 for receiving a pin 60 (e.g., upper pin 60A and lower pin 60B as shown in the drawings). The hinge portion 16 includes four openings 52 with four pins 60 at least partially located within the openings 52. Two pins 60 A (i.e., the pins above a longitudinal axis extending through the midpoint of the hinge portion or the upper pins) are coupled with the upper portion of the case, and two pins 60 B (i.e., the pins below a longitudinal axis extending through the midpoint of the hinge portion) are coupled with the lower portion of the case. A portion of each pin 60 extends from the hinge body 50, a hinge connector 70A connects the hinge portion 16 (via the pin 60A) to the upper portion 12, and a hinge connector 70B connects the hinge portion 16 (via the pin 60B) to the lower portion 14, thereby enabling a user to adjust the angle or configuration of the case.

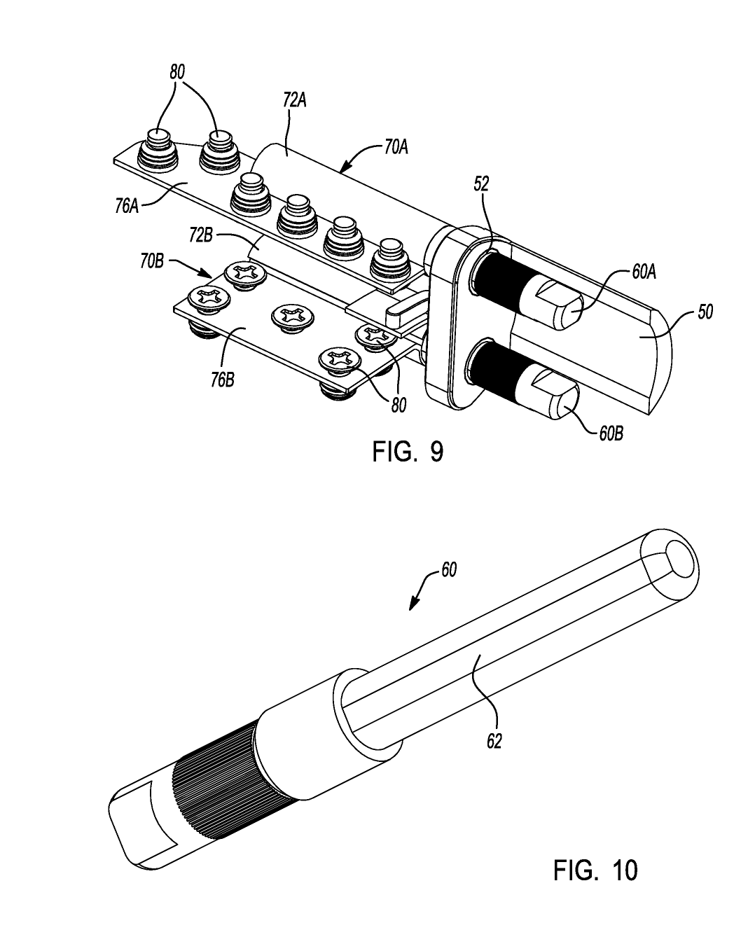

FIG. 8 illustrates a partial cutaway view of the hinge portion 16, which includes a hinge body 50 and four openings 52, each for partially receiving a pin 60. The pins 60 extend outwardly from the hinge body 50 and a hinge connector 70 (e.g., upper hinge connector 70A and lower hinge connector 70B as shown in the drawings) is located at the outwardly-extending portion of each pin 60. The circled portion of FIG. 8 is shown in more detail in FIG. 9.

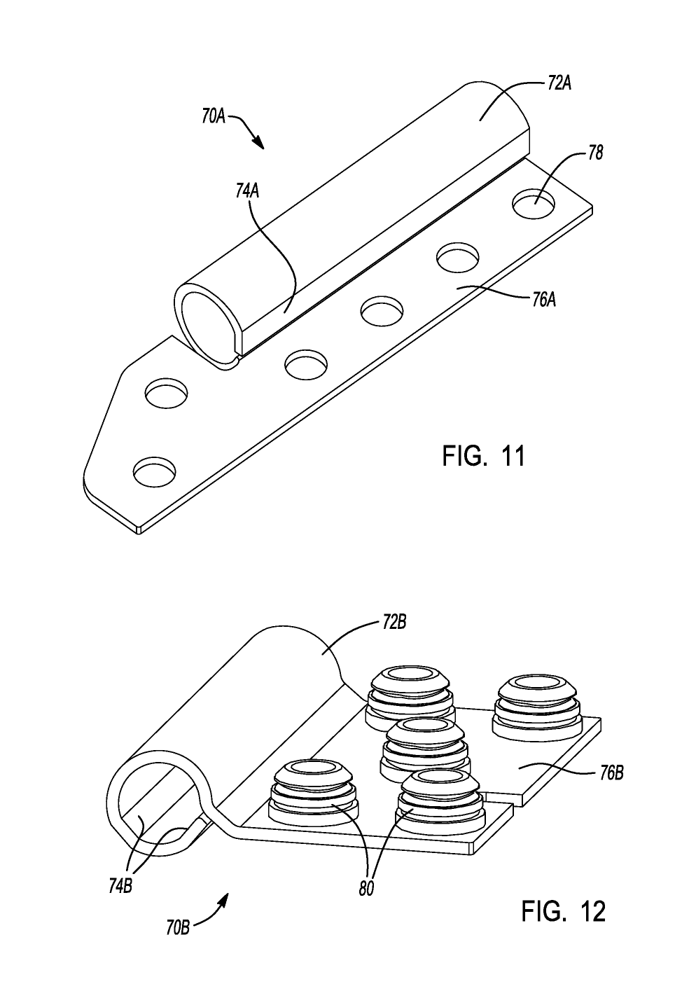

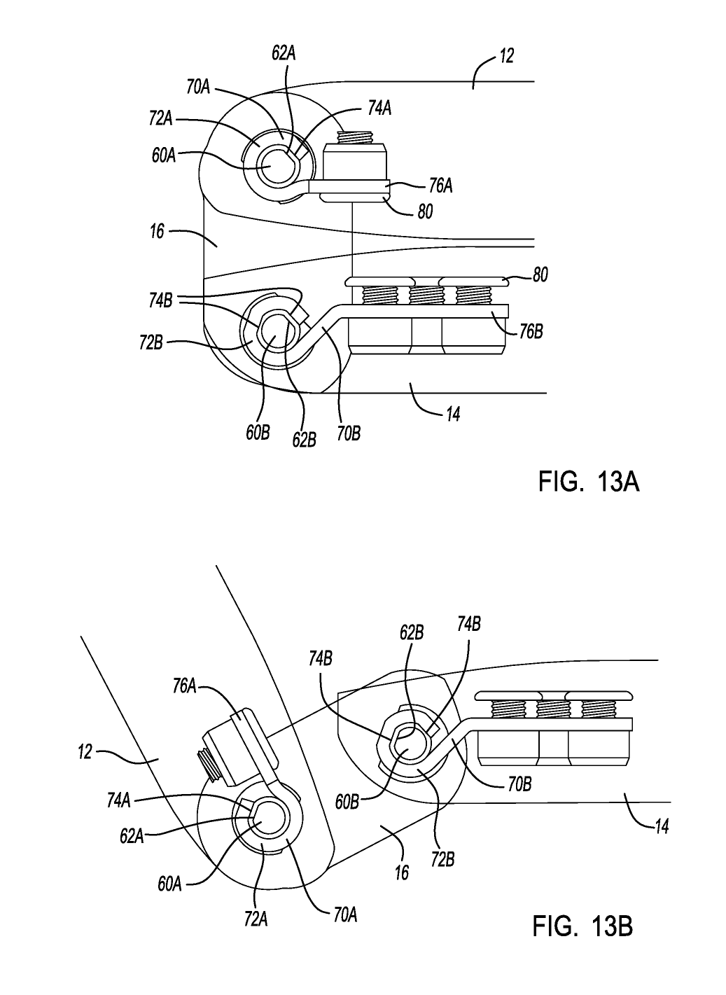

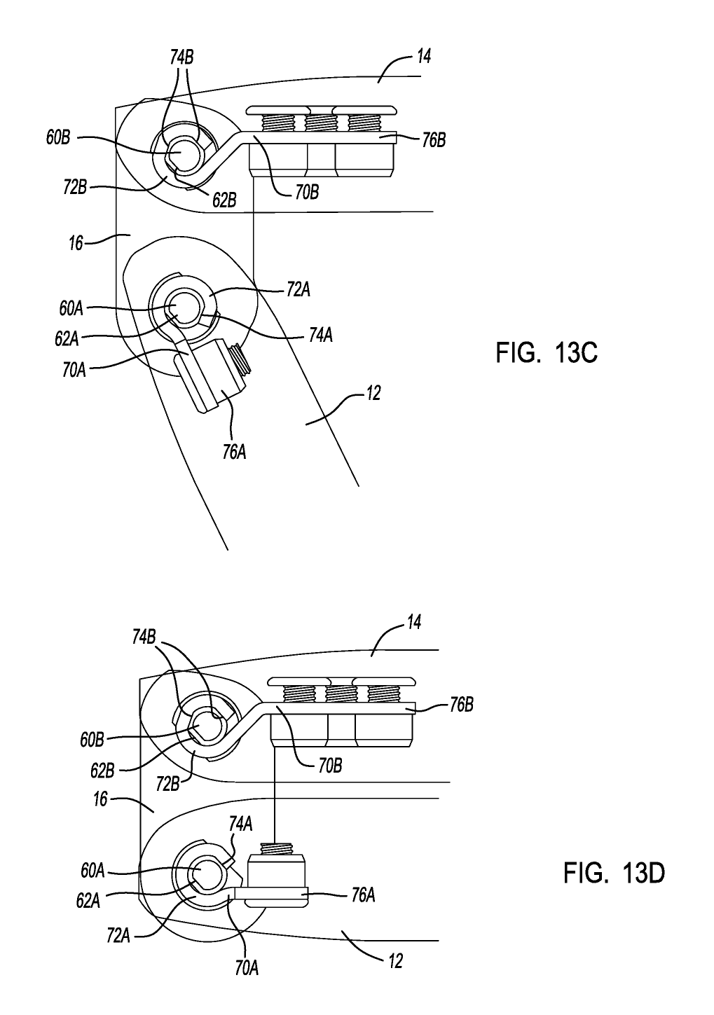

FIG. 9 is an enlarged illustration of a portion of FIG. 8. The hinge body 50 is partially cut away, and pins 60 are received in the openings 52. The outwardly-extending portions of the pins are housed within the hinge connectors 70. The hinge connectors 70 include a pin sleeve portion 72 (e.g., upper pin sleeve portion 72A and lower pin sleeve portion 72B as shown in the drawings), which is a generally hollow sleeve for receiving the pin 60. Each hinge connector 70 also includes an attachment portion 76 (e.g., upper attachment portion 76A and lower attachment portion 76B as shown in the drawings) for attaching the hinge connector 70 to a portion of the case (see e.g., FIGS. 13A-13D). Each attachment portion 76 includes a plurality of fastener openings 78 (see FIG. 11) that each receive a fastener 80 to secure the hinge connector 70 (and hinge portion in general) within the case (i.e., to the upper portion 12 and lower portion 14).

FIG. 10 illustrates a pin 60 removed from a hinge portion 70. The pin 60 includes a flat portion 62 (e.g., upper flat portion 62A and lower flat portion 62B as shown in the drawings) which assists in locking the case in particular positions.

FIG. 11 illustrates a hinge connector 70A removed from the hinge portion 16 (i.e., a hinge connector for connecting the hinge portion 16 and the upper portion 12 of the case). FIG. 12 illustrates a hinge connector 70B removed from the hinge portion 16 (i.e., a hinge connector for connecting the hinge portion 16 and the lower portion 14 of the case). The hinge connectors 70 include a pin sleeve portion 72 for receiving a portion of a pin 60. The pin sleeve portion 72 also includes one or more flat segments 74 for locking the case into particular positions when the flat segment 74 and the flat portion 62 of the pin 60 (see FIG. 13A) are generally parallel and/or generally contact each other. The hinge connector 70 also includes an attachment portion 76 that is generally planar and includes a plurality of fastener openings 78 for receiving a plurality of fasteners 80 (FIG. 12). The fasteners 80 allow the hinge connector 70 to be secured and connected to the upper and lower portions 12, 14 of the case.

As disclosed in the drawings, attachment portion 76A is longer than attachment portion 76B in the direction of the axis of pin 60 and shorter than attachment portion 76B in the direction of the radius of pin 60. As previously described, the dimensional difference between attachment portion 76A and attachment portion 76B allows rotation of the lower pin sleeve portions about the lower pins and connected to the lower portion to occur first when a user opens the case from closed position (e.g., this longer attachment portion may distribute the force from a user rotating the upper portion of the case over the length of the attachment portion, which may allow for ordering the hinge actuation). As previously described, these dimensions may be reversed to reverse the hinge actuation order.

FIGS. 13A, 13B, 13C, and 13D illustrate the hinge portion allowing the electronic device case to be in various positions or configurations and illustrate the hinge actuation order of the electronic device case. FIG. 13A is a partially transparent view of the case and illustrates closed mode. The hinge portion 16 positions the upper portion 12 of the case parallel to the lower portion 14, with the keyboard insert 22 and electronic device 24 facing each other. The side view shows two pins 60 located within and extending from the hinge portion 16 and surrounded by pin sleeve portions 72 of the hinge connectors 70. The same is on the opposite side not shown (e.g., the same configuration may exist on the opposite side of hinge portion 16 and multiple hinge portions 16 can also be used in one case as shown in the drawings). Each pin 60 has a flat portion 62 for securing the hinge portion 16 in a desired position by aligning and/or contacting a flat segment 74 (e.g., upper flat sleeve segment 74A and lower flat sleeve segment 74B as shown in the drawings) of the hinge connector 70. The hinge connector 70 also includes an attachment portion 76A that secures the hinge portion 16 to the upper portion 12 and lower portion 14 of the case via a plurality of fasteners 80. In closed mode, the case remains closed due to the flat segment 74A of the hinge connector 70A at the lower portion 14 and the flat portion 62A of the pin 60A aligning and/or contacting each other. This acts as a detent to hold the case in the closed position until the upper portion 12 and lower portion 14 are purposely separated by a user.

FIG. 13B illustrates a view of the electronic device case focusing on the hinge portion 16 in laptop mode. The upper portion 12 is positioned so that a user can view the screen of the electronic device 24 and use the keyboard insert 22 (see FIGS. 2 and 3), much like using a traditional laptop computer. The lower portion 14 is slightly elevated as it approaches the hinge portion 16, and the case rests on the hinge portion 16 (i.e., the hinge portion 16 where it is generally joined to the upper portion 12). As shown in the drawings, the rear edge 17 of the lower portion 14 is elevated relative to the front edge 15 of the lower portion 15. The pin sleeve portion 72B of the hinge connector 70B joined to the lower portion 14 is allowed to rotate around the pin 60B, and another flat segment 74B (at the area where the lower portion 14 and the hinge portion 16 are connected) aligns and/or contacts the flat portion 62B of the pin 60B, which again acts as a detent to hold the case in laptop mode so that the case remains in position while the user is using the case in this position. The pin sleeve portion 72A of the hinge connector 70A connecting the hinge portion 16 to the upper portion 12 remains in the same position as in FIG. 13A. It is possible that the pin sleeve portion 72A of the hinge connector 70A connecting to the upper portion 12 does not begin to rotate around the pins 60A until rotation has completed of the pins sleeve portion 72B of the hinge connector 70B connecting to the lower portion 14.

FIG. 13C illustrates a view of the electronic device case focusing on the hinge portion 16 in movie mode. In use, movie mode allows a user to position the lower portion 14 with the keyboard insert 22 (not shown) facing downward on a substrate, such as a table, and with the electronic device 24 in the upper portion 12 positioned at an angle that allows the user to view the screen of the electronic device (see FIG. 5). The pin sleeve portions 72A of the hinge connectors 70A connected to the upper portion 12 are allowed to rotate around the pins 60A and allows the user to set the desired angle of the upper portion 12 in relation to the lower portion 14.

FIG. 13D illustrates a view of the case in tablet mode, with the upper portion 12 and lower portion 14 parallel to each other and with the keyboard insert 22 and screen of the electronic device 24 facing away from each other (see FIG. 6). Tablet mode allows a user to use the electronic device in a similar way to using the electronic device without a case. The hinge portion 16 rotates generally about 180 degrees from when the hinge portion 16 was in closed mode (FIG. 13A) (e.g., the hinge portion 12 rotates generally about 180 degrees around the hinge portion 16 compared to closed mode, as shown in the drawings). The pin sleeve portions 72 of the hinge connectors 70 rotate around the pins 60. At the hinge portion 16 where the upper portion 12 is joined to the hinge connector 70A, a flat segment 74A of the pin sleeve portion 72A aligns and/or contacts the flat portions 62 of the pin 60, which allows the case to stay in the tablet mode position (i.e., keeping the upper and lower portions 12, 14 together and not separate or keeping a back face of the upper portion 12 together with a back face of the lower portion 14 as shown in the drawings) until a user separates the upper portion 12 and lower portion 14.

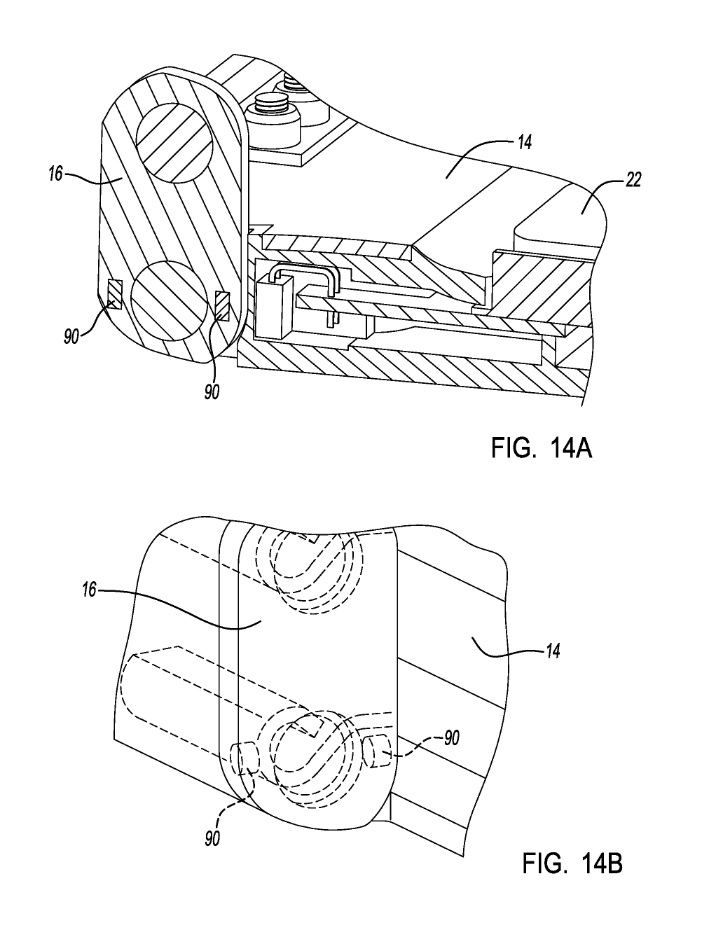

FIGS. 14A and 14B illustrate the hinge portion 16 of the case. The lower portion 14 of the electronic device case contains the keyboard insert 22 and other parts that allow the case to function (e.g., the printed circuit board assembly). The hinge portion 16 includes two magnets 90 on opposing sides of the pin (not shown) at the lower half of the hinge portion (i.e., the portion of the hinge joined to the lower portion 14 of the case). The magnets work with a switch, sensor, and the like 92, which turns the keyboard insert 22 functionality on and off, depending on the position of the case (e.g., switch 92 in lower portion 14 detects alignment with the magnets 90, as described below).

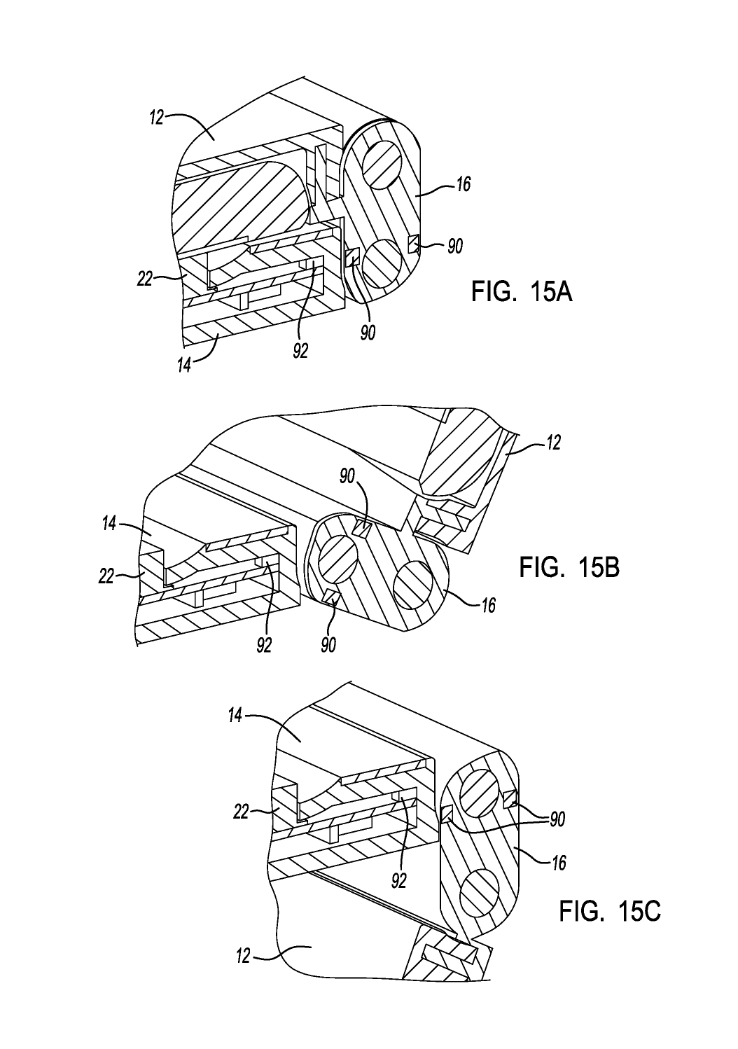

FIGS. 15A, 15B, and 15C illustrate different positions of the case and positions of the magnets 90 that turn the keyboard insert 22 on and off. When the case is in closed mode (FIG. 15A), a user does not require use of the keyboard, as the upper portion 12 and the lower portion 14 block access to the keyboard insert 22. The magnets 90 in the hinge portion 16 align with a switch 92. When the magnets 90 align with the switch 92, this acts to disable the keyboard. When the case is in laptop mode (FIG. 15B), the upper portion 12 is separated from the lower portion 14 into a position much like an open laptop computer. When the case is in this position, it is desirable to use the keyboard insert 22. As the magnets 90 are no longer aligned with the switch 92, the keyboard insert is enabled without a user having to manually turn on the keyboard by a button or manual switch. As a user continues to rotate the case into movie mode or tablet mode (forming an angle between the upper portion 12 and lower portion 14 joined at the hinge portion of greater than 180 degrees), the magnets 90 again are aligned with the switch 92 in the lower portion 14, which disables the keyboard insert 22.

The figures herein show one or more hinge portions. It is contemplated that the hinges function in essentially the same way, even with the difference in the length of the body of the hinge. It is contemplated that when two hinge portions are used, each hinge portion includes only one upper pin and one lower pin and the associated hinge connectors. It is also possible that each hinge portion includes two upper pins and two lower pins and the associated hinge connectors.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A case for an electronic device comprising:
an upper portion configured to reversibly receive and retain the electronic device;
a lower portion including a keyboard and a magnetic sensor;
a hinge portion connecting the upper portion and the lower portion, said hinge portion including:
a housing;
a plurality of upper pins at least partially extending through the housing and including a flattened region on the perimeter of each of the upper pins;
a plurality of lower pins at least partially extending through the housing and including a flattened region on the perimeter of each of the lower pins;
one or more magnets positioned within the housing and external to the perimeter surface of a lower pin;
a unitary upper hinge connector including an upper pin sleeve portion and an upper attachment portion, the upper pin sleeve portion including a flattened region on the inner surface thereof and being rotatably positioned around and at least partially encircling an upper pin and the upper attachment portion being attached to the upper portion; and
a unitary lower hinge connector including a lower pin sleeve portion and a lower attachment portion, the lower pin sleeve portion including a flattened region on the inner surface thereof and being rotatably positioned around and at least partially encircling a lower pin and the lower attachment portion being attached to the lower portion;
wherein when a flattened region on the perimeter of a pin aligns with the flattened region on a sleeve portion, the hinge is in a locked position; and
wherein the sensor is configured to disable the keyboard upon sensing the magnet on the hinge portion.

2. The case of claim 1 wherein the upper attachment portion is shorter in a direction perpendicular to a pin axis than the lower attachment portion and longer in a direction parallel to a pin axis.

3. The case of claim 2 wherein the hinge is configured so that a force applied to the upper portion causes staggered rotation of a lower pin sleeve portion relative to an upper pin sleeve portion.

4. The case of claim 1 wherein the case includes two or more hinge portions.

5. A case for an electronic device comprising:
a first portion configured to reversibly receive and retain the electronic device;
a second portion; and
a hinge portion connecting the first portion and the second portion, said hinge portion including:
a housing;
a plurality of pins at least partially extending through the housing; and
a plurality of hinge connectors including a pin sleeve portion and an attachment portion, the pin sleeve portion being rotatably positioned around and at least partially encircling a pin and the attachment portion being attached to either the first portion or the second portion.

6. The case of claim 5, wherein each of the hinge connectors is a unitary element.

7. The case of claim 5, wherein the case is capable of rotating from a first position wherein a first surface of the first portion faces toward a first surface of the second portion to a second position wherein a second surface of the first portion faces toward a second surface of the second portion, the second surface of the first portion being opposite the first surface of the first portion and the second surface of the second portion being opposite the first surface of the second portion.

8. The case of claim 5, wherein an attachment portion of a hinge connector attached to the first portion is shorter in a direction perpendicular to the pin axis than the attachment portion of a hinge connector attached to the second portion.

9. The case of claim 8, wherein an attachment portion of a hinge connector attached to the first portion is longer in a direction parallel to the pin axis than an attachment portion of a hinge connector attached to the second portion.

10. The case of claim 5, wherein the hinge is configured so that a force applied to the first portion causes staggered rotation of a pin sleeve portion attached to the second portion relative to a pin sleeve portion attached to the first portion.

11. The case of claim 5, wherein a portion includes a counterweight configured to provide a stable platform and offset the weight of the electronic device.

12. The case of claim 5, wherein at least one pin includes a flattened region on the perimeter thereof and at least one pin sleeve portion includes a flattened region on the inner surface thereof.

13. The case of claim 12, wherein the case is configured to be in a partially locked position when a flattened region on the perimeter of a pin aligns with a flattened region on the inner surface of a pin sleeve portion, fixing the first portion or the second portion relative to the hinge portion.

14. The case of claim 12, wherein the case is configured to be in a fully locked position when a flattened region on the perimeter of a pin aligns with a flattened region on the inner surface of a pin sleeve portion attached to the first portion, fixing the first portion relative to the hinge portion and a flattened region on the perimeter of a pin aligns with a flattened region on the inner surface of a pin sleeve portion attached to the second portion, fixing the second portion relative to the hinge portion.

15. The case of claim 12, wherein a flattened region on the perimeter of a pin is aligned with a flattened region on the inner surface of a pin sleeve portion attached to the first portion when the case is in a closed mode and when the case is in a laptop mode.

16. The case of claim 12, wherein a flattened region on the perimeter of a pin is aligned with a flattened region on the inner surface of a pin sleeve portion attached to the second portion when the case is in a movie mode and when the case is in a tablet mode.

17. The case of claim 5, wherein the case includes two or more hinge portions.

18. The case of claim 5, further comprising keyboard in the second portion.

19. The case of claim 18 further comprising at least one sensor for detecting the position of the case and being configured to disable the keyboard when the case is in certain positions.

20. A method for making a case for an electronic device comprising the steps of:
providing a first portion having a frame portion with one or more edges and a recessed area configured to reversibly receive and retain the electronic device;
providing a second portion including a base having a planar portion and a keyboard;
providing a hinge portion including:
a housing;
a plurality of pins at least partially extending through the housing; and
a plurality of hinge connectors including a pin sleeve portion and an attachment portion, the pin sleeve portion being rotatably positioned around and at least partially encircling a pin and the attachment portion being attached to either the first portion or the second portion;
joining the first portion with a first attachment portion of a first hinge connector of the hinge portion via one or more fasteners; and
joining the second portion with a second attachment portion of a second hinge connector of the hinge portion via one or more fasteners.
